(19) United States
(12) Patent Application Publication
(10) Pub. No.: US 2025/0329982 A1
(43) Pub. Date: Oct. 23, 2025

(54) OPTICAL SYSTEM WITH AN ACOUSTO-OPTIC MODULATOR ARRANGED IN A DOUBLE-PASS CONFIGURATION

(71) Applicant: Lumentum Operations LLC, San Jose, CA (US)

(72) Inventors: Ivan GRAUMANN, Zurich (CH); Kutan GUREL, Zurich (CH)

(21) Appl. No.: 18/746,467

(22) Filed: Jun. 18, 2024

Related U.S. Application Data
(60) Provisional application No. 63/636,257, filed on Apr. 19, 2024.

(51) Int. Cl. H01S 3/106; H01S 3/08; H01S 3/10; H01S 3/23

(52) U.S. Cl. CPC H01S 3/1068; H01S 3/08013; H01S 3/10023; H01S 3/2333

(57) ABSTRACT

An optical system includes a laser source component, a first optical amplifier, a circulator, an acousto-optic modulator (AOM), a reflective component, and a second optical amplifier. The laser source component is connected to the first optical amplifier. The first optical amplifier is connected to the laser source component and the circulator. The circulator is connected to the first optical amplifier, the AOM, and the second optical amplifier. The AOM is connected to the circulator and the reflective component. The reflective component is connected to the AOM. The second optical amplifier is connected to the circulator. The circulator, the AOM, and the reflective component are arranged in a double-pass configuration.

### CROSS-REFERENCE TO RELATED APPLICATION

This Patent application claims priority to U.S. Patent Application No. 63/636,257, and entitled “OPTICAL SYSTEM WITH ACOUSTO-OPTIC MODULATOR TO FACILITATE PULSE GENERATION AND TEMPORAL CONTRAST ENHANCEMENT.” The disclosure of the prior Application is considered part of and is incorporated by reference into this Patent Application.

### TECHNICAL FIELD

The present disclosure relates generally to an optical system with an acoustic-optic modulator (AOM), and to an optical system with an AOM in a double-pass configuration.

### BACKGROUND

An ultrafast laser is a type of laser that emits extremely short pulses of light, typically with durations on the order of nanoseconds, or shorter. Such a laser is capable of delivering high peak powers concentrated in very short time intervals.

### SUMMARY

In some implementations, an optical system includes a laser source component; a first optical amplifier; a circulator; an AOM; a reflective component; and a second optical amplifier, wherein: the laser source component is connected to the first optical amplifier, the first optical amplifier is connected to the laser source component and the circulator, the circulator is connected to the first optical amplifier, the AOM, and the second optical amplifier, the AOM is connected to the circulator and the reflective component, the reflective component is connected to the AOM, and the second optical amplifier is connected to the circulator.

In some implementations, a fiber laser system includes a circulator; an AOM; a reflective component; and an optical amplifier, wherein: the circulator is connected to the AOM and the optical amplifier; the AOM is connected to the circulator and the reflective component; the reflective component is connected to the AOM; and the optical amplifier is connected to the circulator.

In some implementations, an optical system includes a circulator; an AOM; a reflective component; and another optical component, wherein: the AOM is connected to the circulator and the reflective component; and the other optical component is connected to the circulator.

### BRIEF DESCRIPTION OF THE DRAWINGS

FIGS. 1A-1B are diagrams of example implementations of an optical system.

FIGS. 2A-2B are diagrams of example paths of a light beam through the optical system.

### DETAILED DESCRIPTION

The following detailed description of example implementations refers to the accompanying drawings. The same reference numbers in different drawings may identify the same or similar elements.

Often, an ultrafast laser needs to provide (e.g., as an output) a laser beam with pulses that have a short duration (e.g., on the order of nanoseconds, or shorter) and high power (e.g., on the order of hundreds or thousands of watts). The ultrafast laser can include an AOM to cause the laser beam to have short pulses (e.g., using a pulse shaping technique) and can include optical amplifiers to increase a power of the laser beams (e.g., before and after pulse shaping). However, amplified spontaneous emission (ASE) is often generated between pulses of the laser beam (e.g., during amplification by the optical amplifiers), which is then also amplified by any subsequent optical amplifiers. If left unchecked, the ASE propagates with the laser beam (e.g., with the “signal” of the laser beam that includes the pulses) and can grow to be a significant fraction of the total output of the ultrafast laser. Therefore, there is a need to minimize the ASE in the laser beam so as to deliver noise-free pulses and to maximize an efficiency of the optical amplifiers of the ultrafast laser.

In some cases, some of the ASE in the laser beam can be removed by sending the laser beam (that includes the signal and the ASE) through an additional AOM (e.g., that gates the signal so as to eliminate the ASE). This is referred to as pulse cleaning or pulse gating. Notably, however, including an additional AOM increases a number of components that need to be included in the ultrafast laser and therefore increases a complexity of the ultrafast laser (e.g., in terms of designing the ultrafast laser, manufacturing the ultrafast laser, and maintaining the ultrafast laser). Including the additional AOM can also increase a footprint (e.g., with respect to a two-dimensional geometry and a three-dimensional geometry) of the ultrafast laser, which can result in the ultrafast laser not being able to be utilized in a practical situation where a smaller footprint is required.

Some implementations described herein include an optical system, which can be included in a fiber laser system (e.g., a fiber laser system configured as an ultrafast laser). The optical system includes a laser source component, a first optical amplifier, a circulator, an AOM (e.g., a single AOM), a reflective component, and a second optical amplifier. The circulator, the AOM, and the reflective component are arranged in a “double-pass” configuration. That is, a laser beam (e.g., that is provided by the laser source component and that is amplified by the first optical amplifier) may propagate, in a first direction and as part of a “first pass,” from the circulator to the AOM and then to the reflective component. As part of the first pass, the AOM may modify the laser beam using a pulse shaping technique to generate a particular pulse shape and/or a particular pulse duration (e.g., on the order of nanoseconds) of the laser beam. Then, the light beam may be reflected by the reflective component and may propagate, in a second direction and as part of a “second pass,” from the reflective component to the AOM and then to the circulator. As part of the second pass, the AOM may modify the laser beam using a pulse cleaning technique to minimize, or to remove, ASE in the laser beam. The circulator then may output the light beam to another optical component that is connected to the circulator, such as the second optical amplifier (e.g., to allow the second optical amplifier to further amplify the laser beam).

In this way, some implementations described herein minimize, or remove, ASE in the laser beam and therefore facilitate delivery of noise-free pulses by the optical system. Further, by minimizing ASE in the laser beam prior to subsequent amplification of the laser beam, an efficiency of the optical amplifiers of the optical system is improved.

Moreover, by using a single AOM to facilitate pulse shaping and pulse cleaning of the laser beam, a fewer number of components are included in the optical system (as compared to utilizing two AOMs, for pulse shaping and pulse cleaning, respectively), which decreases a complexity of the optical system (e.g., in terms of designing the optical system, manufacturing the optical system, and maintaining the optical system). Using a single AOM also decreases a footprint (e.g., with respect to a two-dimensional geometry and a three-dimensional geometry) of the optical system, which can improve a likelihood that the optical system, and the fiber laser that includes the optical system, are able to be utilized in a practical situation where a smaller footprint is required (and where a footprint associated with including two AOMs is too large).

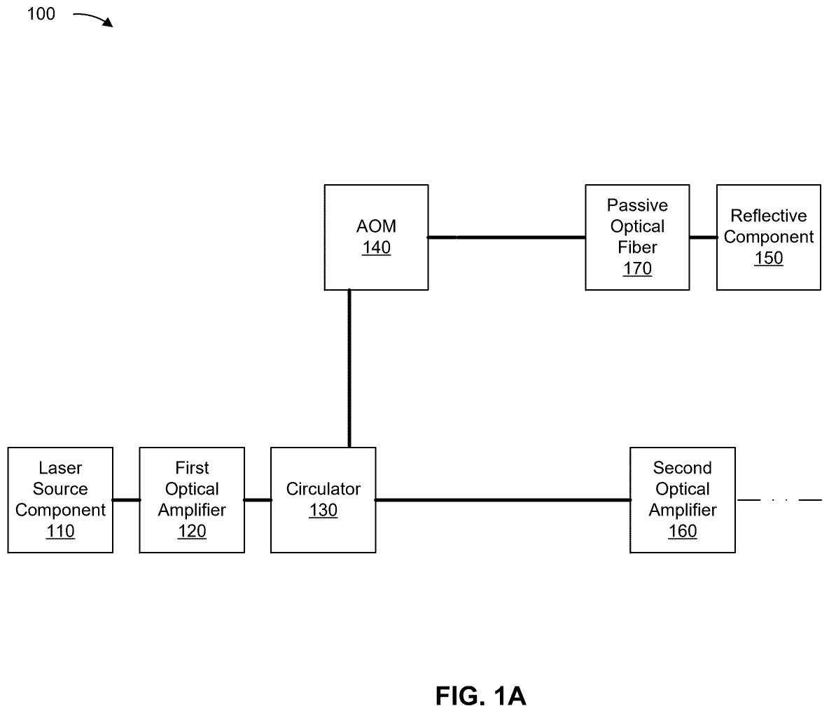

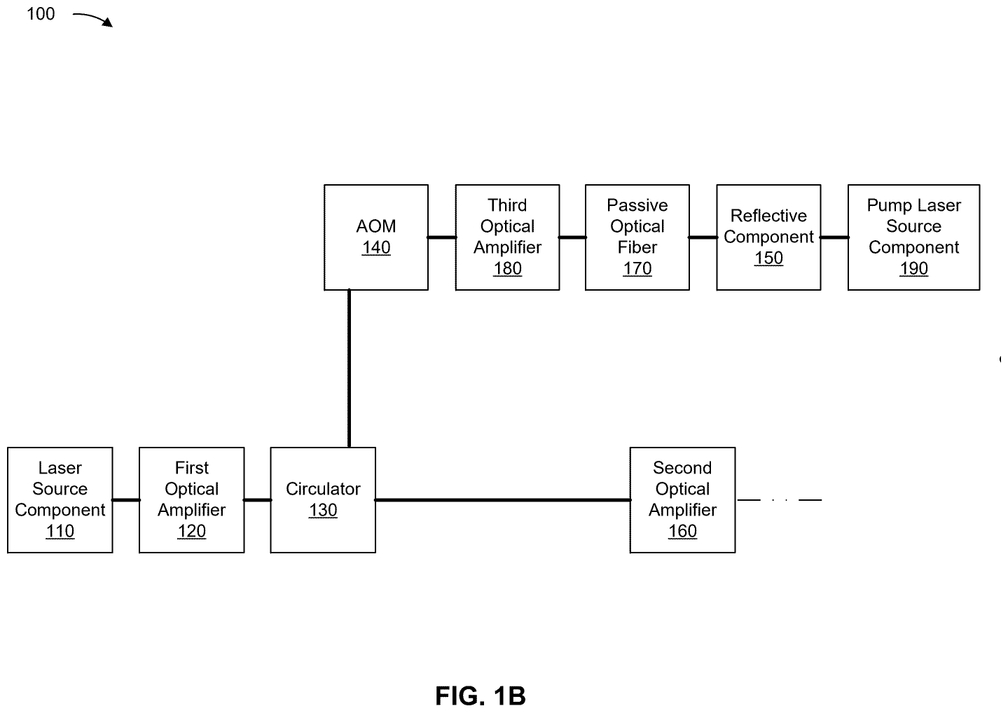

FIGS. 1A-1B are diagrams of example implementations of an optical system 100. The optical system 100 may be included in a laser system, such as a fiber laser system. For example, the optical system 100 may be included in a low-power frontend (LPFE) of a fiber laser system.

As shown in FIGS. 1A-1B, the optical system 100 includes a laser source component 110, a first optical amplifier 120, a circulator 130, an AOM 140, a reflective component 150, a second optical amplifier 160, a passive optical fiber 170, a third optical amplifier 180, and/or a pump laser source component 190. As further described herein, the AOM 140 may be arranged in a double-pass configuration (e.g., within the optical system 100).

The laser source component 110 may be configured to output a laser beam. For example, the laser source component 110 may be a fiber laser that emits the laser beam. The laser beam may comprise, for example, continuous wave (CW) laser light.

Each optical amplifier of the first optical amplifier 120 and the second optical amplifier 160 may be configured to increase a power of a laser beam (e.g., amplify an optical power of a laser beam that propagates through the optical amplifier). For example, the optical amplifier may include a gain medium that is provided with energy by a source, such as a pump laser (not shown in FIGS. 1A-1B), to amplify an optical power of the laser beam. The gain medium may include, for example, a glass fiber doped with rare earth ions (e.g., erbium, neodymium, ytterbium, praseodymium, or thulium), a crystal doped with rare earth ions, or a waveguide in a doped material, among other examples. As another example, the gain medium may include a semiconductor material, such as indium phosphide (InP) or gallium arsenide (GaAs).

The circulator 130 may be configured to direct propagation of laser beams to and from the circulator 130. For example, the circulator 130 may include one or more optical couplers, one or more optical splitters, one or more non-reciprocal elements, and/or one or more other optical elements to direct flow of laser beams through the circulator 130. The circulator 130 may include a first port for receiving a laser beam, a second port for outputting the laser beam and for receiving the laser beam (e.g., after the laser beam is reflected back to the circulator 130, as further described herein), and a third port for outputting the laser beam (e.g., after the laser beam is received via the second port).

The AOM 140 may be configured to modify (e.g., to modulate) a laser beam. For example, the AOM 140 may include an acoustic-optic crystal and a transducer. When an electric signal is applied to the transducer, acoustic waves are generated within the acoustic-optic crystal to enable modification of the laser beam. In some implementations, the AOM 140 may be configured to modify a laser beam using a pulse shaping technique to generate a particular pulse shape and/or a particular pulse duration (e.g., on the order of nanoseconds) of the laser beam, and/or to modify the laser beam using a pulse cleaning technique to minimize, or to remove, ASE in the laser beam. For example, the AOM 140 may be configured to modify, using the pulse shaping technique, a laser beam as the laser beam propagates in a first direction (e.g., from the circulator 130 to the reflective component 150, as further described herein) and may be configured to modify, using the pulse cleaning technique, the laser beam as the laser beam propagates in a second direction (e.g., from the reflective component 150 to the circulator 130, as further described herein).

The reflective component 150 may be configured to reflect a laser beam (e.g., back to a source from which the laser beam propagated to the reflective component 150). For example, the reflective component 150 may include a mirror, a reflector, a fiber Bragg grating (FBG), or other type of optical component configured to reflect wavelengths associated with the laser beam.

The passive optical fiber 170 may be configured to propagate a laser beam from a first end of the passive optical fiber 170 to a second end of the passive optical fiber 170, and vice versa. The passive optical fiber 170 may also be configured to create a propagation delay in the laser beam as the laser beam propagates within the passive optical fiber 170 (e.g., in a particular direction, such as from the first end and the second end, or vice versa). For example, the passive optical fiber 170 may have a particular length such that a time for the laser beam to propagate from the first end to the second end satisfies (e.g., is greater than or equal to) a propagation delay threshold. The propagation delay threshold may be a particular amount of time, which may be greater than or equal to at least one of 50 nanoseconds (ns), 100 ns, 150 ns, or 200 ns, among other examples.

The third optical amplifier 180 may be configured to increase a power of a laser beam (e.g., amplify an optical power of a laser beam that propagates through the optical amplifier) as the laser beam propagates in a first direction (e.g., from the AOM 140 to the reflective component 150, as further described herein) and may be configured to further increase the power of the laser beam as the laser beam propagates in a second direction (e.g., from the reflective component 150 to the AOM 140, as further described herein). For example, the third optical amplifier 180 may include a gain medium (e.g., as described elsewhere herein) that is provided with energy by a source, such as a pump laser (e.g., the pump laser source component 190 shown in FIG. 1B), to amplify an optical power of the laser beam as the laser beam propagates in the first direction and in the second direction.

The pump laser source component 190 may be configured to output a pump laser beam, such as to provide energy for the third optical amplifier 180. For example, the pump laser source component 190 may be a fiber laser that emits the pump laser beam that is injected (e.g., directly, or indirectly, such as via the reflective component 150 and/or the passive optical fiber 170) into the third optical amplifier 180.

As shown in FIGS. 1A-1B, the laser source component 110 may be connected to the first optical amplifier 120; the first optical amplifier 120 may be connected to the laser source component 110 and the circulator 130; the circulator 130 may be connected to the first optical amplifier 120, the AOM 140, and the second optical amplifier 160; the AOM 140 may be connected to the circulator 130 and the reflective component 150; and/or the second optical amplifier 160 may be connected to the circulator 130. In some implementations, the passive optical fiber 170 may connect the AOM 140 and the reflective component 150 (e.g., to each other).

Additionally, or alternatively, as shown in FIG. 1B, the third optical amplifier 180 may be connected to the AOM 140 and the reflective component 150, such as to cause, for example, the AOM 140 to be connected to the reflective component 150 via the third optical amplifier 180 (and, optionally, via the passive optical fiber 170), and the reflective component 150 to be connected to the AOM 140 via the third optical amplifier 180 (and, optionally, via the passive optical fiber 170). The pump laser source component 190 may be connected to the third optical amplifier 180. For example, the pump laser source component 190 may be connected to the third optical amplifier 180 via the reflective component 150 (and, optionally, via the passive optical fiber 170).

Accordingly, the laser source component 110 may be configured to output a laser beam (e.g., to the first optical amplifier 120 or to the circulator 130). The first optical amplifier 120 may be configured to receive the laser beam (e.g., from the laser source component 110), to increase a power of the laser beam, and to output the laser beam (e.g., to the circulator 130). The circulator 130 may be configured to receive the laser beam (e.g., from the first optical amplifier 120 or the laser source component 110) and to output the laser beam (e.g., to the AOM 140). The AOM 140 may be configured to receive the laser beam (e.g., from the circulator 130), to modify the laser beam (e.g., using a pulse shaping technique), and to output the laser beam (e.g., to the reflective component 150). The reflective component 150 may be configured to receive the laser beam (e.g., from the AOM 140) and to reflect the laser beam (e.g., back to the AOM 140). The AOM 140 may be further configured to receive the laser beam (e.g., from the reflective component), to modify the laser beam (e.g., using a pulse cleaning technique), and to output the laser beam (to the circulator 130). The circulator 130 may be further configured to receive the laser beam (e.g., from the AOM 140) and to output the laser beam (e.g., to the second optical amplifier 160). The second optical amplifier 160 may be configured to receive the laser beam (e.g., from the circulator 130), to further increase the power of the laser beam, and to output the laser beam (e.g., to another component of the optical system 100).

In this way, the circulator 130, the AOM 140, and the reflective component 150 may be arranged in a double pass configuration. That is, the laser beam may propagate, in a first direction and as part of a first pass, from the circulator 130 to the AOM 140 and then to the reflective component 150 (e.g., via the passive optical fiber 170 and/or the third optical amplifier 180); and then, the light beam may be reflected by the reflective component 150 and may propagate, in a second direction and as part of a second pass, from the reflective component 150 to the AOM 140 (e.g., via the passive optical fiber 170 and/or the third optical amplifier 180) and then to the circulator 130. The circulator 130 then may output the light beam to another optical component that is connected to the circulator 130, such as the second optical amplifier 160.

Further, the passive optical fiber 170 may connect the AOM 140 and the reflective component 150, and may therefore be configured to propagate the laser beam between the AOM 140 and the reflective component 150 (e.g., in the first direction and in the second direction). In some implementations, the passive optical fiber 170 may also be configured to create a propagation delay in the laser beam as the laser beam propagates in a particular direction between the AOM 140 and the reflective component 150. In this way, because the laser beam propagates via the passive optical fiber 170 in the first direction and in the second direction, a total propagation delay associated with the laser beam may be twice the propagation delay (e.g., in one direction) associated with the passive optical fiber 170.

In some implementations, the passive optical fiber 170 may be configured to cause a total propagation delay of the laser beam that is great enough to allow the AOM 140 a sufficient amount of time to switch between light beam modification techniques (e.g., after outputting the laser beam to the reflective component 150 and before receiving the laser beam from the reflective component 150). This therefore enables optimal pulse shaping and optimal pulse cleaning of the laser beam. For example, an amount of time that is needed to switch between modifying, using the pulse shaping technique, the laser beam (e.g., as the laser beam propagates in the first direction from the circulator 130 to the reflective component 150) and modifying, using the pulse cleaning technique, the laser beam (e.g., as the laser beam propagates in the second direction from the reflective component 150 to the circulator 130) may be less than or equal to the total propagation delay. Accordingly, the propagation delay threshold associated with the passive optical fiber 170 (described elsewhere herein) may be greater than or equal to half the amount of time to switch between light beam modification techniques.

Additionally, or alternatively, the third optical amplifier 180 may connect the AOM 140 and the reflective component 150 (in addition to, or in place of, the passive optical fiber 170) and may therefore be configured to propagate the laser beam between the AOM 140 and the reflective component 150 (e.g., in the first direction and in the second direction). Further, the third optical amplifier 180 may be configured to increase the power of the laser beam as the laser beam propagates in the first direction (e.g., from the AOM 140 to the reflective component 150) and to further increase the power of the laser beam as the laser beam propagates in the second direction (e.g., from the reflective component 150 to the AOM 140). In this way, the third optical amplifier 180 may enable a power of the laser beam to be increased to a higher level, prior to propagating to the second optical amplifier 160, than when the third optical amplifier 180 is not included in the optical system 100.

As indicated above, FIGS. 1A-1B are provided as an example. Other examples may differ from what is described with regard to FIGS. 1A-1B.

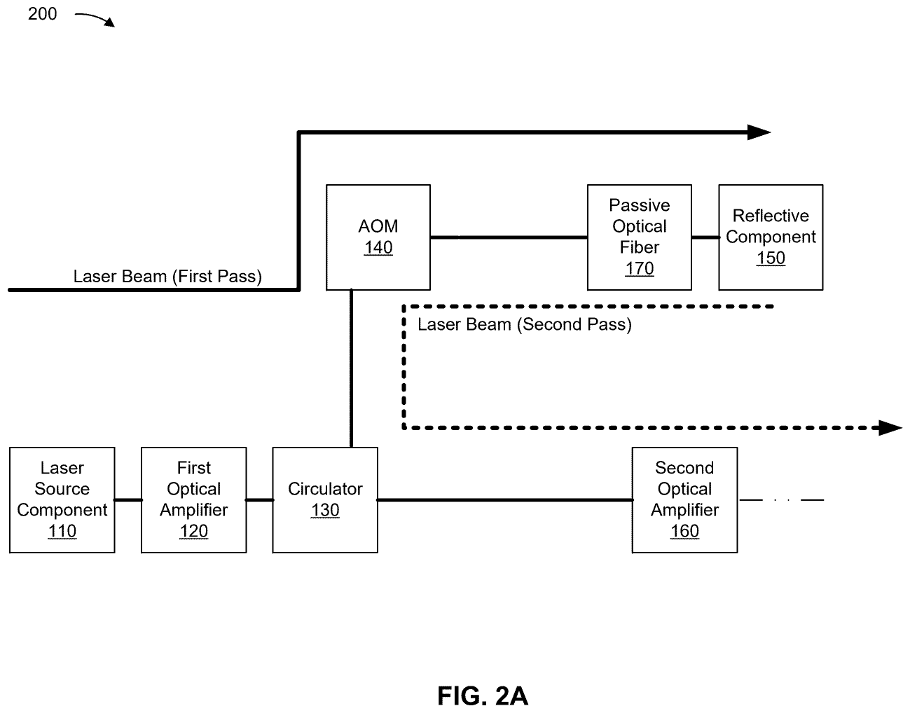

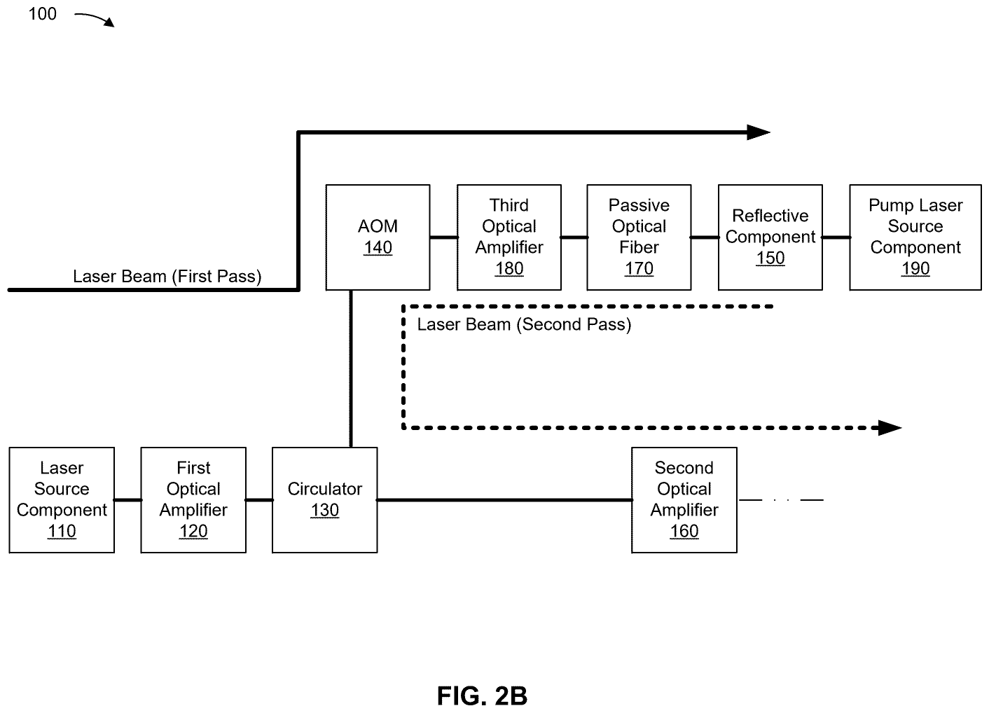

FIGS. 2A-2B are diagrams of example paths 200 of a light beam through the optical system 100. FIG. 2A corresponds to the example implementation of the optical system 100 shown in FIG. 1A, and FIG. 2B corresponds to the example implementation of the optical system 100 shown in FIG. 1B.

As shown by the solid arrow in FIG. 2A, a laser beam, as part of a first pass, may propagate from the laser source component 110 to the first optical amplifier 120 (e.g., that increases a power of the laser beam), to the circulator 130, to the AOM 140 (e.g., that modifies the laser beam using a pulse shaping technique), and to the reflective component 150 (e.g., via the passive optical fiber 170). The reflective component 150 may reflect the laser beam, and therefore the laser beam, as shown by the dotted arrow in FIG. 2A and as part of a second pass, may propagate (e.g., via the passive optical fiber 170) from the reflective component 150 to the AOM 140 (e.g., that modifies the laser beam using a pulse cleaning technique), to the circulator 130, and to the second optical amplifier 160 (e.g., that further increases a power of the laser beam).

Alternatively, as shown by the solid arrow in FIG. 2B, a laser beam, as part of a first pass, may propagate from the laser source component 110 to the first optical amplifier 120 (e.g., that increases a power of the laser beam), to the circulator 130, to the AOM 140 (e.g., that modifies the laser beam using a pulse shaping technique), to the third optical amplifier 180 (e.g., that further increases a power of the laser beam), and to the reflective component 150 (e.g., via the passive optical fiber 170). The reflective component 150 may reflect the laser beam, and therefore the laser beam, as shown by the dotted arrow in FIG. 2B and as part of a second pass, may propagate (e.g., via the passive optical fiber 170) from the reflective component 150 to the third optical amplifier 180 (e.g., that further increases a power of the laser beam), to the AOM 140 (e.g., that modifies the laser beam using a pulse cleaning technique), to the circulator 130, and to the second optical amplifier 160 (e.g., that further increases a power of the laser beam).

As indicated above, FIGS. 2A-2B are provided as an example. Other examples may differ from what is described with regard to FIGS. 2A-2B.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An optical system, comprising:
a laser source component;
a first optical amplifier;
a circulator;
an acousto-optic modulator (AOM);
a reflective component; and
a second optical amplifier, wherein:
the laser source component is connected to the first optical amplifier,
the first optical amplifier is connected to the laser source component and the circulator,
the circulator is connected to the first optical amplifier, the AOM, and the second optical amplifier,
the AOM is connected to the circulator and the reflective component,
the reflective component is connected to the AOM, and
the second optical amplifier is connected to the circulator.

2. The optical system of claim 1, wherein:
the circulator, the AOM, and the reflective component are arranged in a double-pass configuration.

3. The optical system of claim 1, wherein:
the laser source component is configured to output a laser beam to the first optical amplifier;
the first optical amplifier is configured to receive the laser beam from the laser source component, to increase a power of the laser beam, and to output the laser beam to the circulator;
the circulator is configured to receive the laser beam from the first optical amplifier and to output the laser beam to the AOM;
the AOM is configured to receive the laser beam from the circulator, to modify the laser beam using a pulse shaping technique, and to output the laser beam to the reflective component;
the reflective component is configured to receive the laser beam from the AOM and to reflect the laser beam back to the AOM;
the AOM is further configured to receive the laser beam from the reflective component, to modify the laser beam using a pulse cleaning technique, and to output the laser beam to the circulator;
the circulator is further configured to receive the laser beam from the AOM and to output the laser beam to the second optical amplifier; and
the second optical amplifier is configured to receive the laser beam from the circulator, to further increase the power of the laser beam, and to output the laser beam to another component of the optical system.

4. The optical system of claim 1, wherein:
the AOM is configured to modify, using a pulse shaping technique, a laser beam as the laser beam propagates in a first direction from the circulator to the reflective component; and
the AOM is configured to modify, using a pulse cleaning technique, the laser beam as the laser beam propagates in a second direction from the reflective component to the circulator.

5. The optical system of claim 1, wherein the optical system further includes a passive optical fiber that connects the AOM and the reflective component.

6. The optical system of claim 5, wherein the passive optical fiber is configured to create a propagation delay in a laser beam as the laser beam propagates in a particular direction between the AOM and the reflective component.

7. The optical system of claim 1, wherein the optical system further includes a third optical amplifier connected to the AOM and the reflective component, wherein:
the AOM is connected to the reflective component via the third optical amplifier; and
the reflective component is connected to the AOM via the third optical amplifier.

8. The optical system of claim 7, wherein:
the third optical amplifier is configured to increase a power of a laser beam as the laser beam propagates in a first direction from the AOM to the reflective component; and
the third optical amplifier is configured to further increase the power of the laser beam as the laser beam propagates in a second direction from the reflective component to the AOM.

9. A fiber laser system, comprising:
a circulator;
an acousto-optic modulator (AOM);
a reflective component; and
an optical amplifier, wherein:
the circulator is connected to the AOM and the optical amplifier;
the AOM is connected to the circulator and the reflective component;
the reflective component is connected to the AOM; and
the optical amplifier is connected to the circulator.

10. The fiber laser system of claim 9, wherein:
the circulator, the AOM, and the reflective component are arranged in a double-pass configuration.

11. The fiber laser system of claim 9, wherein:
the circulator is configured to receive a laser beam and to output the laser beam to the AOM;
the AOM is configured to receive the laser beam from the circulator, to modify the laser beam using a pulse shaping technique, and to output the laser beam to the reflective component;
the reflective component is configured to receive the laser beam from the AOM and to reflect the laser beam back to the AOM;
the AOM is further configured to receive the laser beam from the reflective component, to modify the laser beam using a pulse cleaning technique, and to output the laser beam to the circulator;
the circulator is further configured to receive the laser beam from the AOM and to output the laser beam to the optical amplifier; and
the optical amplifier is configured to receive the laser beam from the circulator, to increase a power of the laser beam, and to output the laser beam to another component of the fiber laser system.

12. The fiber laser system of claim 9, wherein:
the AOM is configured to modify, using a pulse shaping technique, a laser beam as the laser beam propagates in a first direction from the circulator; and
the AOM is configured to modify, using a pulse cleaning technique, the laser beam as the laser beam propagates in a second direction from the reflective component.

13. The fiber laser system of claim 9, wherein the fiber laser system further includes a passive optical fiber that connects the AOM and the reflective component.

14. The fiber laser system of claim 13, wherein the passive optical fiber is configured to create a propagation delay in a laser beam as the laser beam propagates in a particular direction between the AOM and the reflective component.

15. The fiber laser system of claim 9, wherein the fiber laser system further includes another optical amplifier connected to the AOM and the reflective component, wherein:
the AOM is connected to the reflective component via the other optical amplifier; and
the reflective component is connected to the AOM via the other optical amplifier.

16. The fiber laser system of claim 15, wherein:
the other optical amplifier is configured to increase a power of a laser beam as the laser beam propagates in a first direction from the AOM; and
the other optical amplifier is configured to further increase the power of the laser beam as the laser beam propagates in a second direction from the reflective component.

17. An optical system, comprising:
a circulator;
an acousto-optic modulator (AOM);
a reflective component; and
another optical component, wherein:
the AOM is connected to the circulator and the reflective component; and
the other optical component is connected to the circulator.

18. The optical system of claim 17, wherein:
the circulator, the AOM, and the reflective component are arranged in a double-pass configuration.

19. The optical system of claim 17, wherein:
the circulator is configured to receive a laser beam and to output the laser beam to the AOM;
the AOM is configured to receive the laser beam from the circulator, to modify the laser beam using a pulse shaping technique, and to output the laser beam to the reflective component;
the reflective component is configured to receive the laser beam from the AOM and to reflect the laser beam back to the AOM;
the AOM is further configured to receive the laser beam from the reflective component, to modify the laser beam using a pulse cleaning technique, and to output the laser beam to the circulator; and
the circulator is further configured to receive the laser beam from the AOM and to output the laser beam to the other optical component.

20. The optical system of claim 17, wherein:
the AOM is configured to modify, using a pulse shaping technique, a laser beam as the laser beam propagates in a first direction; and
the AOM is configured to modify, using a pulse cleaning technique, the laser beam as the laser beam propagates in a second direction.
